(19) United States
(12) Patent Application Publication
(10) Pub. No.: US 2013/0198999 A1
(43) Pub. Date: Aug. 8, 2013

(54) Line Gripping Device

(71) Applicant: Leonard M. Ferguson, Grand Blanc, MI (US)

(72) Inventor: Leonard M. Ferguson, Grand Blanc, MI (US)

(21) Appl. No.: 13/366,550

(22) Filed: Feb. 6, 2012

(51) Int. Cl. F16G 11/00

(52) U.S. Cl. 24/129 R

(57) ABSTRACT

An improved line gripping device comprising a spindle (11) having a gripping aperture (12) and a spindle shaft (14) with the gripping aperture (12) constructed slightly larger than the spindle shaft (14). The spindle shaft (14) having a spindle shaft bore (18) formed at a right angle with respect to the spindle shaft (14). The spindle shaft (14) further including two spindle shaft oblique groves (16) and (17) that progress obliquely and rotationally away from the spindle shaft bore (18) and toward the gripping aperture (12). Other embodiments are described and made known.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

### Prior Art

The following is a tabulation of some prior art that at present appears relevant:

U.S. Patents

| Pat. No. | Kind Code | Issue Date | Patentee |
|---|---|---|---|
| 5,839,385 | B1 | 1998-10-24 | Hersh |
| 4,843,687 | B1 | 1989-07-04 | Kroepelin |
| 3,744,098 | B1 | 1973-07-10 | Bowers |
| 6,672,237 | B2 | 2004-01-06 | Hillier |
| 7,490,387 | B2 | 2009-02-17 | Hiller |

It is known that line gripping devices for string, chord, or rope are a critical component used, yet not limited to, shipping, boating, aviation, and landscape. It should be understood that the phrase “line” will be denoted hereafter to identify a string, chord, rope, or any linear material capable of being employed with this line gripping device.

When tying down an article for transport or adjusting a tree tie down, specifically when a line is wet or soiled, it is difficult to obtain a firm grip on the line. After the line is drawn tight, it becomes more difficult to secure the line to a stationary point without pulling the line and tying a knot. Furthermore, as time passes and the line fixes itself into the knot, the knot becomes difficult, if not impossible to untie, thus resulting in wasted time and resources.

Presently lines are tied to hooks, inserted into cleats, or the line is simply tied to an object for attachment. However, many times consumers have a difficult time removing the line if it is tied directly to an object after the line becomes settled into the knot, making the knot hard to remove as aforementioned. Furthermore, many line cleats currently manufactured are produced with pointed edges and crushing actions that dig into the line, consequently reducing the strength and performance of the line.

Thereafter, several types of line cleating devices have been designed in an effort to ease the manipulation of lines. With respect to prior art, Hersh U.S. Pat. No. 5,839,385 (1998) discloses a device which can hook onto a line by wrapping the line around two hook members that are attached to a rigid body; however, this cleating device provides limited support for a secured line if the user inadvertently lets go of the device. Furthermore, if the line breaks, this device, specifically its hook members, could become disadvantageous. Kroepelin U.S. Pat. No. 4,843,687 (1989) shows a device with clamping cams that allow the user to attach a line and apply force; however, this cleating device uses teeth to grip the line and a large cumbersome handle. Bowers U.S. Pat. No. 3,744,098 (1973) shows a line gripping device that uses cam and jam as a means for latching onto a rope, also using a teeth locking mechanism. Lastly, Hillier patent(s) U.S. Pat. No. 6,672,237 (2004) and U.S. Pat. No. 7,490,387 (2009) has two devices that use spring actuated mechanisms, one that contains a circular aperture that is based on shearing force to hold the line and one that comprises teeth.

My device describes a line securing apparatus that incorporates line wrapping and bending with the use of pressure and friction in an effort to eliminate sharp edges that could subsequently damage the line. Having said this, most of the securing devices heretofore known suffer from a host of weaknesses such as:
(a) The lines are held in position using pointed edges or line wrapping without securing
(b) The lines are not secured in a way that allows the user to release the mechanism while maintaining a movable advantage over the line
(c) The products are cumbersome and cannot be used for multiple purposes such as:
   1. Mechanical advantage of a soiled line while attaching the line to a secure location
   2. Pulling a line then attaching and letting go of the device without device separation
   3. Releasing the device from a fixed point without removing the line from the device
   4. Pinch points
   5. Inability to produce tension on a line in multiple directions without removing the line from the device

### ADVANTAGES

Accordingly a number of advantages of one or more aspects are as follows: to provide a means for gripping a line, that can be moved along the line without binding, that can secure the line without damage to the line, that is neat with a uniform appearance, that is relatively inexpensive to produce, that has limited moving parts, that can be easily manufactured with diverse materials, and that can be easily attached to the line and apply tension to the line in multiple directions. Additional advantages of one or more aspects will be apparent from a consideration of the drawings and ensuing description. Some of these advantages will include, yet not shown, attaching a line to a snow sled, securing a clothes line to a pole, or hooking a tire swing to a rope. Within the drawings there are two examples presented, one using the device on a ladder rung, and the other as a pulling means.

### SUMMARY OF THE INVENTION

In accordance with one embodiment a line gripping device comprised of a circular rigid body having a shaft with an annular passage and two oblique groves that are contiguous with the annular passage, further including a gripping aperture at the distal end of the embodiment.

### BRIEF DESCRIPTION OF THE DRAWINGS

FIG. 1 shows a device with an enlarged end and a shaft containing a bore and two oblique groves that are contiguous with and start at each side of the bore and progress to some extent half way around each side of the shaft in accordance with one embodiment.

FIG. 2 shows a similar device as mentioned in FIG. 1 with the bore turned vertical showing the direction and ending points of the two oblique groves in accordance with another embodiment.

FIG. 3 shows a similar device as in FIG. 2 with the bore turned vertical and displaying a line that is passing through the bore and following the two oblique groves that start at each side of the bore in accordance with another embodiment.

FIG. 4 shows a similar device as in FIG. 1 further including a hollow shaft that has a bore at a right angle to the surface of the hollow shaft that passes through the hollow shaft in accordance with another embodiment.

FIG. 5 shows a similar device as in FIG. 4 with the hollow shaft bore in line with the device bore ready for a line to pass through the embodiment in accordance with another embodiment.

FIG. 5A shows a similar embodiment as in FIG. 5 with a line inserted through the hollow shaft bore and device bore in accordance with another embodiment.

FIG. 6 shows a similar embodiment with the device seated against the hollow shaft and in line with the hollow shaft bore representing a lockable position in accordance with other embodiments.

FIG. 7 shows the device disclosed in the subject invention employed into ladder rungs with one end of the ladder rung sectioned thereby showing the line gripping device in a locked position with a line inserted.

FIG. 8 shows an alternate embodiment of the subject invention integrated into a pulling method for lines where the device is attached to a hollow shaft with locking pins located in multiple areas within the subject invention in accordance with other embodiments.

Drawings - Reference Numerals

| | | | |
|---|---|---|---|
| 11 | spindle | 12 | gripping aperture |
| 13 | spindle insertion direction | 14 | spindle shaft |
| 15 | barrel insertion direction | 16 | spindle shaft oblique grove |
| 17 | spindle shaft oblique grove | 18 | spindle shaft bore |
| 20 | spindle stop | 22 | line |
| 22a | line exiting spindle shaft | 22b | line exiting spindle shaft |
| | bore | | bore |
| 23 | barrel rotating direction | 24 | spindle rotating direction |
| 25 | spindle shaft bore radius | 26 | barrel |
| 27 | line passing through device | 28 | barrel bore |
| 30 | ladder rung | 32 | locking pins |
| 36 | removable locking pin | 37 | direction of tension |
| 38 | fixed locking pin | | |

### DETAILED DESCRIPTION

### First Embodiment

Referring first to FIG. 1, an embodiment of a spindle 11 is illustrated. The spindle 11 consists of rigid material that can be manufactured by milling or injection molding. However, milling or injecting molding is my preferred means to produce this embodiment; other means could be employed such as casting, water jet, or laser cutting. Presently, this embodiment was produced using aircraft grade aluminum, but other rigid materials are suitable. The spindle 11 has an enlarged gripping aperture 12 of uniform size in which the user is able to grasp the spindle 11 and turn the spindle 11 in a clockwise direction as shown in 24 (FIG. 5). Although the enlarged gripping aperture 12 cross section is shown as a round solid shaft, it can have different cross sections that allow the user to grasp with any suitable means, such as a wrench. The spindle 11 also consists of a spindle shaft 14 that can be manufactured as part of the gripping aperture 12 and is of uniform diameter, and to some extent, smaller than the gripping aperture 12. The spindle shaft 14 consists of a rigid member that has a spindle shaft bore 18 that is formed at a right angle to the surface of the spindle shaft 14. The spindle shaft 14 has two spindle shaft oblique grooves 16, 17 that are contiguous with and start at the entrance of each side of the spindle shaft bore 18 and follow an oblique pattern away from the spindle shaft bore 18 in a rotationally oblique direction toward the gripping aperture 12. At the entrance of each side of the spindle shaft bore 18 and where the two spindle shaft oblique grooves 16, 17 are contiguous with the spindle shaft bore 18, a spindle shaft bore radius 25 is cut or formed in an anti-snag manner that allows the line 22 (FIG. 3) to transition out of the spindle shaft bore 18 and move along the two spindle shaft oblique grooves 16, 17 without encountering any pointed or sharp edges. At the location where the spindle shaft 14 and the gripping aperture 12 meet, a spindle stop 20 is formed to limit the rotation and insertion of the spindle shaft 14.

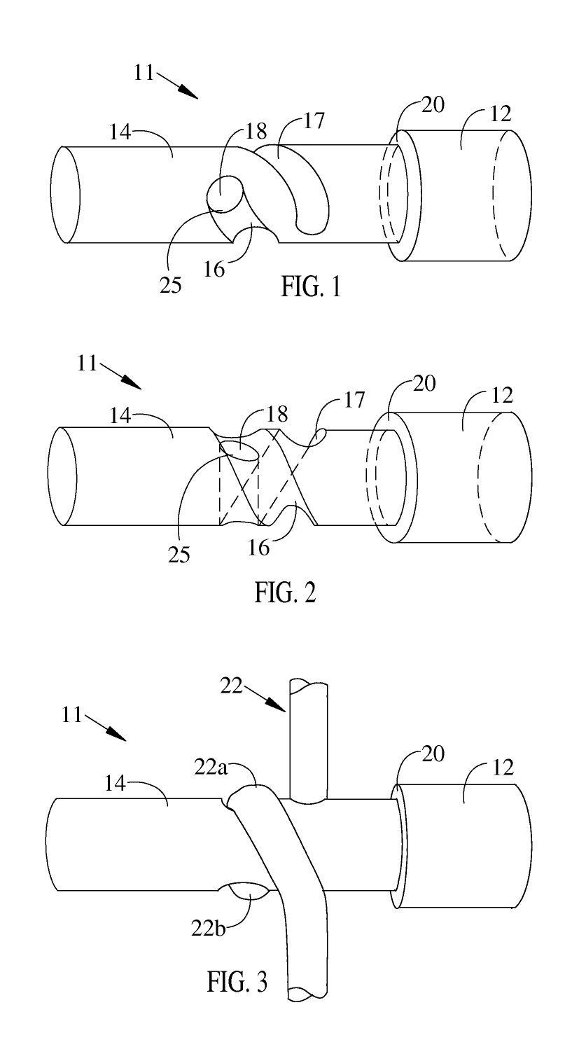

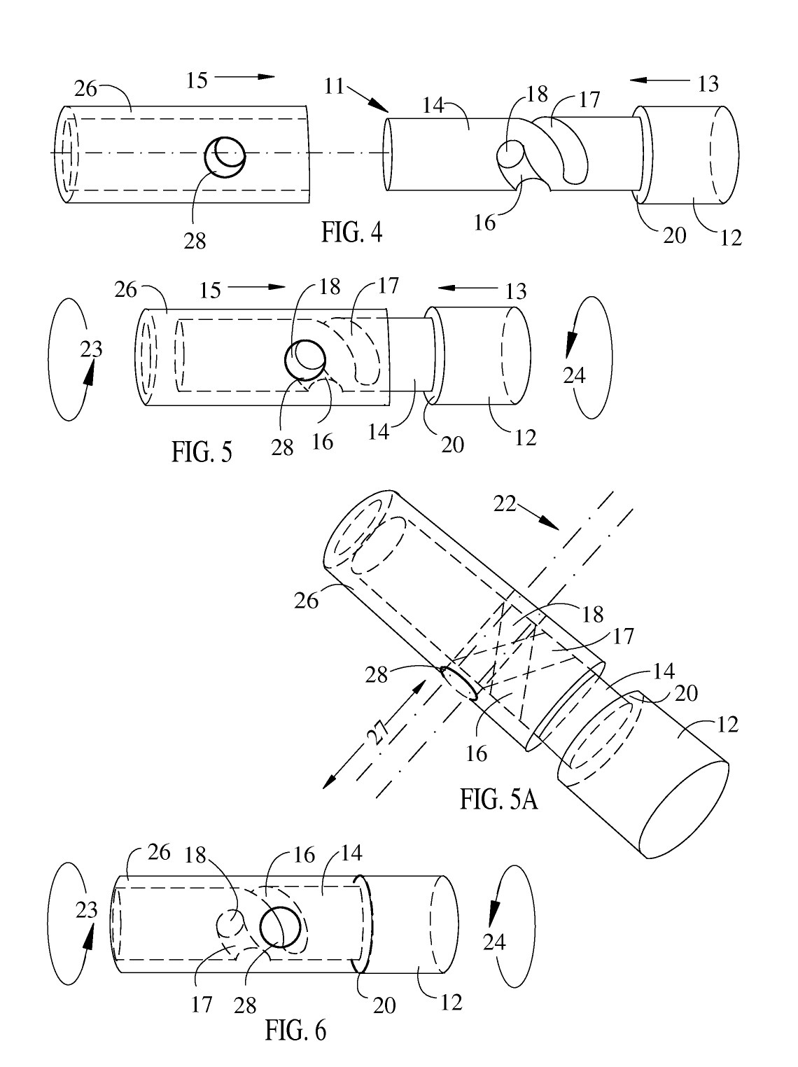

FIG. 2 shows another embodiment of the spindle 11 where the spindle shaft bore 18 is turned vertical in relation to the view in FIG. 1 and where the spindle shaft bore 18 can be viewed as an annular passage through the spindle shaft 14. In FIG. 2 a perspective view with hidden lines present the direction of the two spindle shaft oblique grooves 16, 17. At the entrance of the spindle shaft bore 18 the spindle shaft 14 shows an oblique grove 16 that is concave and allows the line 22a (FIG. 3) to pass without contacting any pointed or sharp edges. The oblique groove 17 is formed in the same fashion as the oblique grove 16, yet communicates with the opposite side of the spindle shaft bore 18. The spindle shaft oblique grooves 16, 17 are cut or formed to a depth that allows the line 22 (FIG. 3) to fit within the spindle shaft oblique groves 16, 17 while allowing the line to experience friction from the device chosen to encase the spindle shaft such as shown and will be described hereafter in FIG. 4 using a barrel 26.

FIG. 3 shows another embodiment of the spindle 11 with the line 22 inserted through the spindle shaft bore 18 (FIG. 2) and following the two spindle shaft oblique groves 16, 17 (FIG. 2). Now looking at 22a and 22b the line 22 passes through the spindle shaft bore 18 (FIG. 2) and turns toward the gripping aperture 12 on different sides around the spindle shaft 14 while following the spindle shaft oblique groves 16, 17 also outlined in (FIG. 2) for one half the circumference of the spindle shaft 14. The spindle stop 20 restricts over rotation of the spindle shaft 14.

Looking at both FIG. 2 and FIG. 3, when the line 22 passes through the spindle shaft bore 18 and then turning the line 22 over the edge of the spindle shaft bore radius 25 (FIG. 2) on opposite sides and in same direction around the spindle 14 within the spindle shaft groves 16, 17, the device is able to lock onto the line 22 by use of line bending and friction. This friction is further multiplied by the spindle shaft oblique groves 16, 17, bending the line around the spindle shaft bore radius 25, and pressing the line against the inside surface of a device employed as a barrel 26 (FIG. 4) (example shown in FIG. 4) that is to some extent larger than the spindle shaft 14. By moving the line 22 around the spindle shaft 14 in an oblique pattern, the spindle shaft 14 retains its strength by means of shifting the position of the line 22 away from the spindle shaft bore 18 and over a more rigid area of the spindle shaft 14. This in turn allows the line 22 to be wrapped in an oblique path rather than a strict circumferential path, thus allowing more surface area to contact the line.

FIGS. 4, 5, 5A, and 6 shows perspective views of the spindle 11 (FIG. 1) being incorporated into a barrel 26 that has a barrel bore 28 passing through the barrel 26 at a right angle to the surface of the barrel 26. However, the barrel 26 outside aspect is formed as a circular member; the outside profile can be formed as any conceivable shape, such as, for example, a hexagon, square, or oval. The inside diameter of the barrel 26 is required to be circular and to some extent, larger than the spindle shaft 14 as to allow the spindle shaft 14 to pass unimpeded through the inside of the barrel 26 and contribute to the total friction of the line 22 (FIG. 3).

Now looking at FIG. 4, the spindle 11 is shown poised in the spindle insertion direction 13 to the barrel 26 and the barrel 26 is shown poised in the barrel insertion direction 15. As the spindle 11 is initially inserted into the barrel 26 the spindle shaft bore 18 and the barrel bore 28 are to be inline. This annular passage allows a line to pass freely through the barrel 26 and the spindle shaft 14 after the barrel bore 28 and the spindle shaft bore 18 are aligned. This action will further be explained hereafter.

FIG. 5 shows the spindle shaft 14 inserted into the barrel 26 with the spindle shaft bore 18 aligned with the barrel bore 28. At this point the device is ready for the line 22 (FIG. 5A) to pass unobstructed through the device. As noted in FIG. 5A, the line 22 is allowed to pass in both directions 27 through the embodiment before any twisting action has occurred. In FIG. 5 after the line 22 (FIG. 5A) is inserted, the gripping aperture 12 is grasped and the barrel 26 is grasped at the distal end of the barrel 26 and the gripping aperture 12 is turned in the spindle rotating direction 24 moving in the spindle insertion direction 13 and the barrel is turned in the barrel rotating direction 23 moving in barrel insertion direction 15 to spindle shaft 14. As the line 22 (FIG. 5A) enters the barrel 26 and travels around the spindle shaft oblique groves 16, 17, the line is pulled into the barrel until the barrel bore 28 is in line with the distal end of the spindle shaft oblique groves 16, 17, away from the spindle shaft bore 18. At this point the barrel 26 is touching the spindle stop 20 and will be explained hereafter.

Displayed in FIG. 6 is a completed rotation of the spindle shaft 14 and the barrel 26. The barrel 26 is shown touching the spindle stop 20. When the barrel 26 is touching the spindle stop 20, this represents a locking position thereafter pins can be inserted into rigid portions of the spindle shaft 14 as will be described in FIG. 8. Narrowly looking at and comparing FIG. 5 with FIG. 6, specifically the spindle shaft oblique groves 16, 17, the spindle shaft oblique groves 16, 17 are symmetrical, however when the device is rotated (23, 24) using the gripping aperture 12 and the distal end of the barrel 26, the ending position of the spindle shaft oblique groves 16, 17 are on opposite sides of the spindle shaft 14. At this point the spindle shaft bore 18 is inside the barrel 26 and away from the barrel bore 28, and the barrel bore 28 maintains the direction of the line 22 (FIG. 5A) and provides an exit point for the line 22 (FIG. 5A). As aforementioned, the exterior surface of the barrel 26 can take on any conceivable shape, however the inside dimension of the barrel 26 must be in close proximity to the spindle shaft 14 thus allowing friction to develop between the device and a line employed. Furthermore, the entry point of the barrel bore 28 is required to have curved edges to eliminate snagging of the line 22 (FIG. 5A).

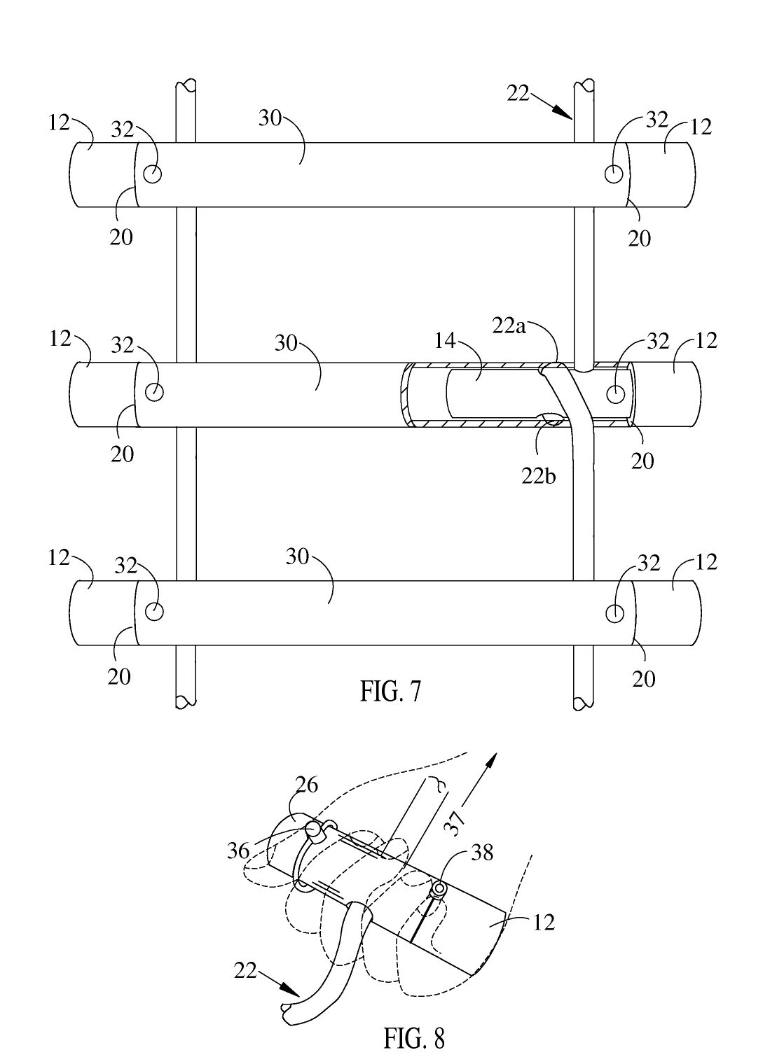

FIG. 7 shows one application of the device employed into ladder rungs. The ladder rung 30 is formed similar to the barrel 26 (FIG. 4) such that the inside diameter of the ladder rung 30 is required to be to some extent larger than the spindle shaft 14. The ladder rung 30 outside dimension can take on any conceivable shape, similar to the barrel 26 (FIG. 4), however it is important that the inside diameter be formed in a manner that allows limited clearance between the outside diameter of the spindle shaft 14 and the inside diameter of the ladder rung 30. This close tolerance between the inside diameter of the ladder rung 30 and the spindle shaft 14 allows friction of the line 22 to be distributed across the spindle shaft oblique groves 16, 17 (FIG. 1) and the inside diameter of the ladder rung 30. After the line is twisted in place using the twisting action described in 23, 24 (FIG. 5) and the ladder rung 30 is touching the spindle stop 20, a locking pin 32 is inserted through an annular hole in the ladder rung 30 and the spindle shaft 14. Although the locking pin 32 can be inserted in any position along the spindle shaft 14, it is preferable that the locking pin 32 be inserted into the strongest portion of the spindle shaft 14. The locking pin 32 prohibits the spindle shaft from spinning inside the ladder rung 30 when there is vertical pressure employed on the ladder rung 30. As aforementioned, the line 22 and the bending of the line 22a, 22b press against the inside of the device employed to encase the spindle shaft 14 creating friction across the spindle shaft 14 and the line 22.

FIG. 8 shows the barrel 26 and spindle 11 (FIG. 1) being used as a pulling means. After a line 22 is inserted into the barrel 26 and spindle 11, twisted as described in 23, 24 (FIG. 5) and a locking pin 38 or 36 is in place, the line can be pulled in any direction such as 37 and let go without the device detaching from the line 22. Furthermore, the device can then be used as a hooking means after the barrel 26 and spindle 11 are locked in place using a locking pin 36 or 38. For example, the device can be attached to an eye hook in a clothes line pole or slipped through a loop formed in the end of a line. Furthermore, the device can be unlocked quickly by removing the locking pin 36 or 38 and then pulling on both sides of the line 22. It is not necessary to grasp the gripping aperture 12 or the barrel 26 to unlock the line. This pulling action forces the spindle shaft 14 (FIG. 7) to spin counterclockwise and unlock the line. After the line 22 is unlocked, the device can be moved along the line 22 and relocked in any number of positions.

### ADVANTAGES

As described above, many advantages become evident:

(a) This device provides an easy way to grip onto a line without reducing line performance using sharp edges and crushing moments, thus reduces material waste.

(b) The device is easy to move along a line and relock in multiple positions without removing the device from the line.

(c) The device is relatively easy to produce and has limited moving parts that could snag onto a line and inadvertently damage the line.

(d) Although a variety of line cleat devices are manufactured, this device can be manufactured using multiple methods and materials thus allowing the device to be employed in a number of applications, such as, clothing, aviation, or boating.

(e) This device has the potential of being manufactured in multiple sizes, depending on the application and the size of the line employed.

### CONCLUSION, RAMIFICATIONS, AND SCOPE

Accordingly, the reader will notice that the line gripping device is practical in many applications from boating to aviation, industry to homeowners. The device can be removed quickly and easily from the line, moved along the line, and reattached and locked with little effort. In addition, the device is relatively inexpensive to produce, neat with a uniform appearance, and can be manufactured from most rigid materials. The description above should be viewed as illustrations and not limit the scope of the embodiments. As an example, the line locking device can take on other shapes, specifically the gripping aperture, such as, for example, a square, oval, hexagon, etc. Therefore, the scope of these embodiments should be determined by the claims, not by the examples provided.

The embodiment in which an exclusive property or privilege is claimed are defined as follows:

1. A line gripping device comprising a spindle having a predetermined gripping aperture that communicates with a spindle shaft wherein said spindle shaft comprising a spindle shaft bore formed at a right angle through said spindle shaft thereof and a plurality of oblique concave groves in said spindle shaft that are contiguous with said spindle shaft bore.

2. The line gripping device of claim 1 wherein said gripping aperture is to be located at the distal end of said spindle.

3. The line gripping device of claim 1 wherein said gripping aperture is to some extent larger than said spindle shaft and said gripping aperture is integrally attached to said spindle shaft.

4. The line gripping device of claim 1 wherein said spindle shaft is integrally attached to said gripping aperture and said spindle shaft is to some extent smaller than said gripping aperture.

5. The line gripping device of claim 1 wherein said spindle shaft comprising said spindle shaft bore of sufficient size that passes through said spindle shaft.

6. The line gripping device of claim 5 wherein said spindle shaft bore incorporates round edges at both entries of said spindle shaft bore.

7. The line gripping device of claim 1 wherein said oblique concave groves are of sufficient size and are contiguous with said spindle shaft bore in said spindle shaft.

8. The line gripping device of claim 1 wherein said spindle shaft bore further including said oblique concave groves incorporates anti-snag by means of rounded edges.

9. The line gripping device of claim 1 wherein said spindle shaft bore enables a line to pass without resistance through said spindle shaft.

10. The line gripping device of claim 1 wherein said oblique concave groves are formed in a manner that allow a line to develop friction across said oblique concave groves.

11. The line gripping device of claim 1 wherein said oblique concave groves start at each side of said spindle shaft bore and rotate obliquely around said spindle shaft for one half the circumference of said spindle shaft.
whereby said spindle will improve said line friction and employ means for said anti-snag, thereby substantially increasing line performance.
